(19) United States
(12) Patent Application Publication
(10) Pub. No.: US 2008/0078356 A1
(43) Pub. Date: Apr. 3, 2008

(54) Control device for internal-combustion engine

(75) Inventor: Masamichi Akagawa, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/902,719

(22) Filed: Sep. 25, 2007

(30) Foreign Application Priority Data
Sep. 29, 2006 (JP) 2006-267681

(51) Int. Cl. F02D 9/08

(52) U.S. Cl. 123/403

(57) ABSTRACT

A control device for an internal-combustion engine has a casing having an intake passage through which intake air is supplied to a combustion chamber of the internal-combustion engine, an intake air control valve which is arranged at the intake passage, an actuator for actuating a shaft of the intake air control valve, and an engine control unit for controlling the actuator based on an operation state of the internal-combustion engine. The engine control unit makes an operation of the internal-combustion engine continue until a predetermined period has elapsed since an engine key switch became OFF, and controls the actuator such that an opening degree of the intake air control valve is in a predetermined valve closed state where the suction control valve is closed.

### CROSS REFERENCE TO RELATED APPLICATION

This application is based on a Japanese Patent Application No. 2006-267681 filed on Sep. 29, 2006, the disclosure of which is incorporated herein by reference.

### FIELD OF THE INVENTION

The present invention relates to a control device for an internal-combustion engine.

### BACKGROUND OF THE INVENTION

An intake air control device of an internal combustion engine having an intake air flow control valve disposed at a downstream side of a throttle valve in the intake pipe of the internal combustion engine mounted in a vehicle such as an automobile has been publicly known, for example, with reference to JP-11-247661A. In the intake air control device of this internal combustion engine, an actuator such as a stepping motor is employed as a valve driving unit for driving the shaft of the intake air flow control valve.

Moreover, generally, an intake air control device of an internal combustion engine performs an intake air control in the following manner. That is, when the internal combustion engine is started or idled, the intake air control device controls an actuator in such a way that the valve opening degree of an intake air flow control valve is brought to the state of a completely-closed opening degree to cause an intake air vortex in the combustion chamber of the internal combustion engine. Moreover, when the internal combustion engine is normally driven, the intake air control device controls the actuator in such a way that the valve opening degree of the intake air flow control valve is brought to the state of a completely-opened opening degree to pass the intake air straight through an intake passage to stop causing the intake air vortex.

However, the intake air control device of the internal combustion engine described in JP-11-247661A employs a cantilever type valve in which the shaft of the intake air flow control valve is shifted in position to one end from the center of the intake air flow control valve. Thus, a dead space exists in the lower surface of the intake air flow control valve when the intake air flow control valve is brought to the state of the completely-opened opening degree (that is, when the intake air flow control valve is fully opened).

For this reason, there is a possibility that while a vehicle such as an automobile is running or is stopped, moisture contained in the intake air and water drops intruding from the outside of the intake pipe will collect in the dead space.

Moreover, in the intake air control device of the internal combustion engine, a bearing portion for journaling (rotatably supporting) a shaft slidably in the rotation direction is disposed near the dead space. Therefore, there is a possibility that water collecting in the dead space will intrude also into a clearance between the shaft and the bearing portion and hence will collect in the clearance. Further, there is a possibility that water will collect also in a clearance between the two side surfaces of the axial direction of the intake air flow control valve and the passage wall surface of the intake passage.

In this case, in general, the intake air flow control valve is constructed so as to be biased by the load of a spring or the like in such a way that when the engine key switch is turned off, that is, the engine key switch is switched from an IG position to an ACC position or an OFF position for the purpose of stopping driving the internal combustion engine, the intake air flow control valve is brought to the state of a fully opened opening.

In this manner, in the case of the intake air control device in which the intake air flow control valve is held in the state of the fully opened opening after the internal combustion engine is stopped, there is a possibility that water adhering to or remaining in the vicinity of the intake air flow control valve will be iced at the intake air flow control valve to lock the intake air flow control valve.

In this case, there will be presented a problem that even if the actuator is controlled so as to completely close the intake air flow control valve when the internal combustion engine is started next time under a cold environment (when the vehicle is parked under cold environment (for example, below a freezing point) in the winter or the like and then the internal combustion engine is started), it is difficult to completely close the intake air flow control valve.

### SUMMARY OF THE INVENTION

In view of the above-described disadvantages, it is an object of the present invention to provide a control device for an internal combustion to restrict an intake air control valve from being frozen and locked and from malfunctioning due to the icing of water adhering to or remaining in the vicinity of the intake air control valve, and to restrict the intake air control valve from malfunctioning when the internal combustion engine is started under a cold environment.

According to the present invention, a control device for an internal-combustion engine has a casing having an intake passage through which intake air is supplied to a combustion chamber of the internal-combustion engine, an intake air control valve which is arranged at the intake passage, an actuator for actuating a shaft of the intake air control valve, and an engine control unit for controlling the actuator based on an operation state of the internal-combustion engine. The engine control unit makes an operation of the internal-combustion engine continue until a predetermined period has elapsed since an engine key switch was OFF, and controls the actuator such that an opening degree of the intake air control valve is in a predetermined valve closed state where the suction control valve is closed.

Thus, when or immediately after the engine key switch is turned off, the water adhering to or remaining in the vicinities of the intake air control valve can be removed by the use of the intake air negative pressure of the engine, that is, the strong intake air flows (main intake air flow and subordinate intake air flow) passing through the clearances between the intake air control valve and the passage wall surfaces of the intake passage.

Therefore, when or immediately after the specified time passes after the engine key switch is turned off, that is, when or immediately after driving the engine is stopped, water is removed from the vicinities of the intake air control valve. Thus, the intake air control valve 5 can be restricted from being frozen or being brought into a malfunction by the icing of water adhering to or remaining in the vicinities of the intake air control valve 5 after the engine is stopped or when the engine is started next time under a cold environment.

### BRIEF DESCRIPTION OF THE DRAWINGS

Other objects, features and advantages of the present invention will become more apparent from the following detailed description made with reference to the accompanying drawings, in which:

FIG. 1 is a schematic view showing an intake air control device for an internal-combustion engine according to a first embodiment of the present disclosure;

FIG. 2 is a block diagram showing an engine control system according to the first embodiment;

FIG. 3A is a schematic front view showing an intake air vortex generating member according to the first embodiment, and FIG. 3B is a schematic sectional view taken along the line IIIB-IIIB in FIG. 3A;

FIG. 4A is a schematic sectional view showing the intake air vortex generating member according to the first embodiment, and FIG. 4B is a schematic sectional view taken along the line IVB-IVB in FIG. 4A;

FIG. 5 is a schematic perspective view showing a valve unit (cartridge) according to the first embodiment;

FIG. 6 is a timing chart showing an engine control after an engine key switch is turned off according to the first embodiment; and

FIG. 7 is a schematic sectional view showing an intake air vortex generating member according to a second embodiment of the present disclosure.

### DETAILED DESCRIPTION OF THE EXAMPLED EMBODIMENTS

### First Embodiment

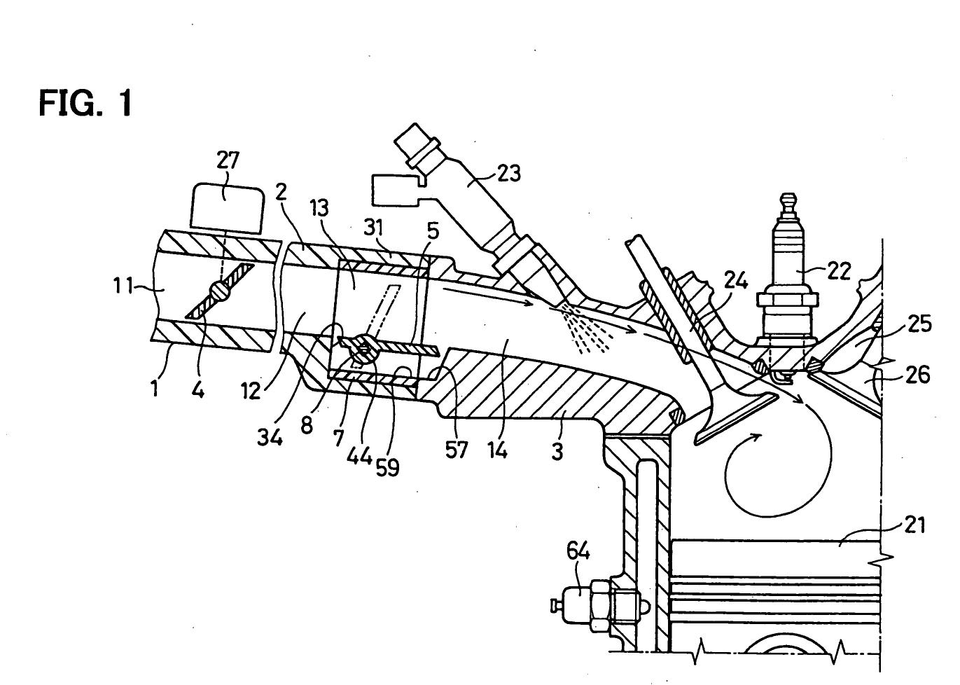

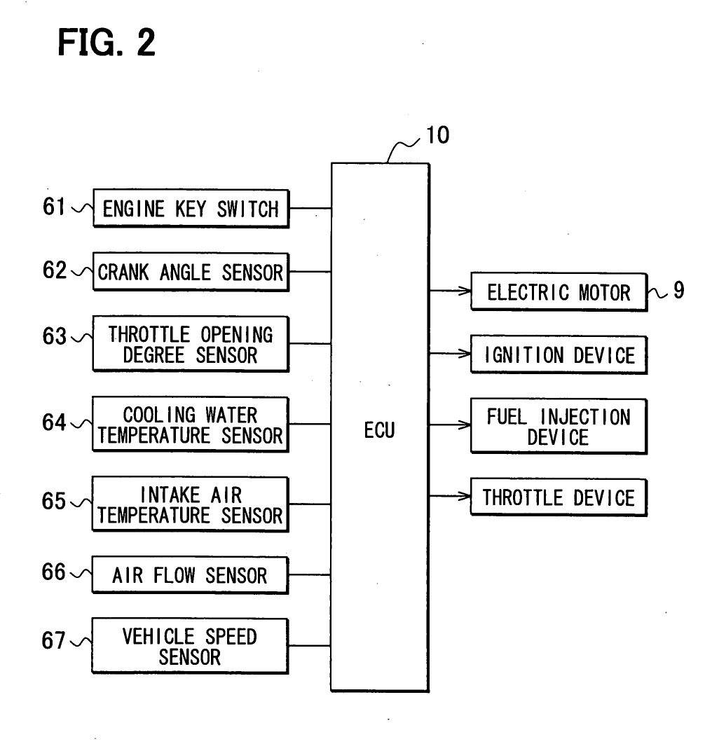

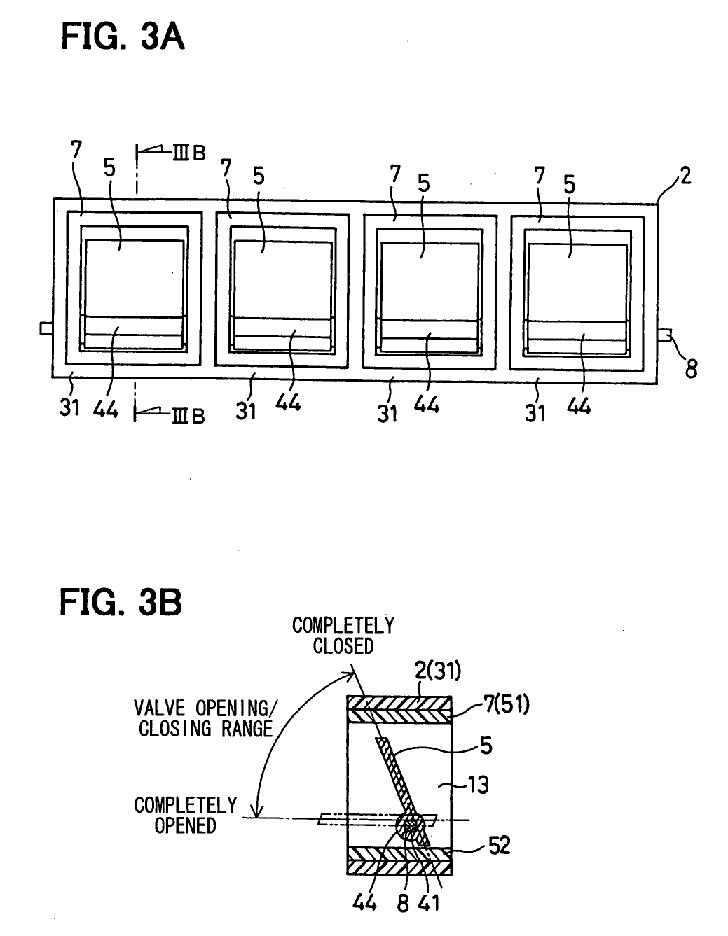

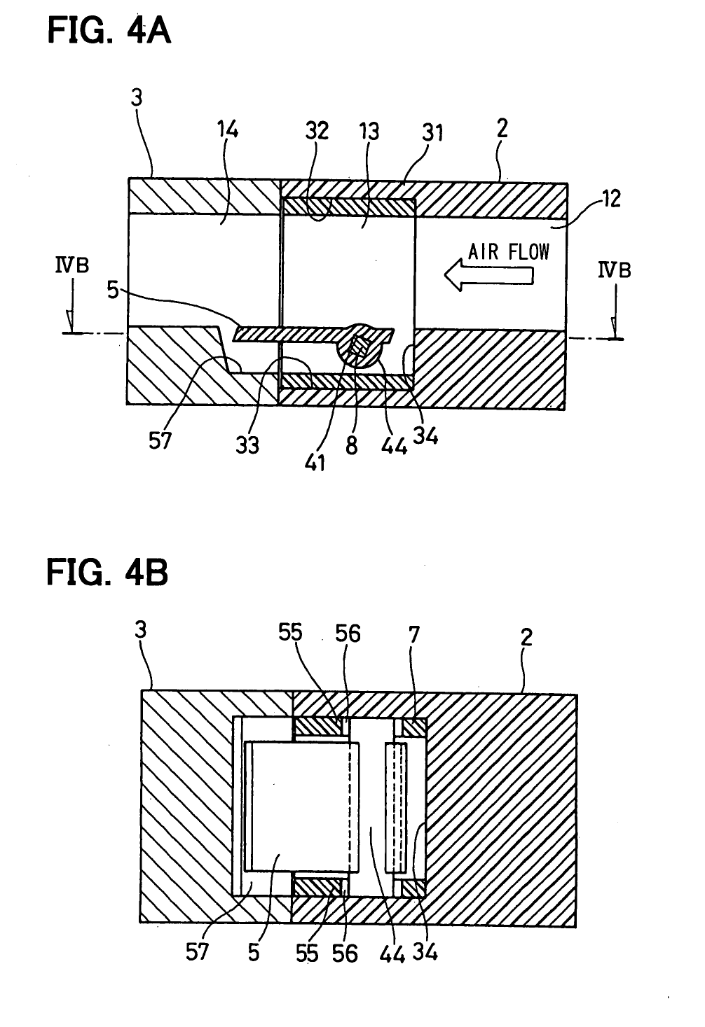

A control device (engine control system) for an engine according to a first embodiment of the present invention will be described according to FIGS. 1-6. The control device can be suitably used as an intake air control device for an internal combustion engine (for example, four-cylinder gasoline engine) having an intake air vortex generating member capable of producing an intake air vortex for promoting the combustion of an air-fuel mixture in each cylinder of the internal combustion engine mounted in an engine room (engine cabin) of a vehicle, for example, an automobile.

In this case, the engine generates power by thermal energy obtained by combusting the air-fuel mixture of intake air and fuel in a combustion chamber, and is constructed of a four-cycle engine which repeats four stokes including an intake stroke, a compression stroke, an expansion (combustion) stroke, and an exhaust stroke as a cycle.

The engine has intake ducts 1 (engine intake pipes) for supplying suction air (intake air) into the combustion chambers of the respective cylinders of the engine, and exhaust ducts (engine exhaust pipes) for exhausting exhaust gas flowing out of the respective cylinders of the engine through an exhaust purification device to the outside.

The engine intake pipe 1 can be constructed of a casing which defines therein intake passages 11, 12 and 13 for supplying the intake air into the combustion engine of the engine. The engine intake pipe 1 includes an air cleaner case for housing and holding an air cleaner (filtering element) for filtering the intake air, a throttle body which is combined with a downstream side (in the direction of flow of the intake air) of the air cleaner, a surge tank which is combined with the downstream side (in the direction of flow of the intake air) of the throttle body, and an intake manifold 2 which has a double pipe structure and is combined with the downstream side (in the direction of flow of the intake air) of the surge tank.

A cylinder head 3 of the engine is substantially hermetically combined with the downstream end of the intake manifold 2. Moreover, a throttle valve 4 is disposed at a halfway portion of the engine intake pipe 1, that is, in the throttle body (intake passage 11), in such a manner that the throttle valve 4 is capable of being freely opened and closed.

According to this embodiment, the intake air control device (intake air vortex generating member) of the internal combustion engine is provided with the intake manifold 2 which constructs the downstream portion of the engine intake pipe 1, a plurality of intake air control valves (intake air flow control valve, or tumble control valve which is hereinafter referred to as “TCV”) for producing an intake air vortex (tumble flow) in a longitudinal direction in the intake air flowing in the intake manifold 2 (intake passages 11 and 12), a valve driving unit (actuator) for changing the valve opening degrees (rotational angles) of all of the TCVs by one operation via a pin rod 8 (shaft), and an engine control unit 10 which can be constructed of an electronic control unit (ECU) to control the opening degree of the TCV in relation to respective systems of an ignition unit, a fuel injection unit, and an intake air quantity control unit (throttle unit) and the like.

The engine has a cylinder head 3, and a cylinder block forming the combustion chamber into which the air-fuel mixture is sucked through a suction port 14 (intake port). The suction port 14 is disposed in the cylinder head 3 and has a shape of a three-dimensional intake passage. A piston 21 coupled to a crankshaft via a connecting rod is supported in a cylinder bore formed in the cylinder block, in such a manner that the piston 21 is slidable in the up-down direction shown in the drawing.

A spark plug 22 is mounted to the cylinder head 3 of the engine in such a manner that the spark plug 22 exposes its tip into the combustion chamber of each cylinder. Moreover, an injector 23 (electromagnetic fuel injection valve) for injecting fuel into the intake port 14 at optimum timing is mounted to the cylinder head 3.

The plurality of intake ports 14 formed at the one side of the cylinder head 3 are opened and closed by poppet-type intake valves 24, and a plurality of exhaust ports 25 formed at the other side of the cylinder head 3 are opened and closed by poppet-type exhaust valves 26.

The ignition unit according to this embodiment is a system in which when the piston 21 is moved up, the air-fuel mixture in the combustion chamber of each cylinder of the engine is compressed and ignited, thereby being combusted.

The ignition unit is constructed of an ignition coil for producing a high voltage for igniting the air-fuel mixture, and the spark plug 22 for making a spark by the current of high voltage produced by the ignition coil to ignite the air-fuel mixture.

The fuel injection unit of this embodiment is a system for injecting and supplying fuel into the intake port 14 of each cylinder of the engine.

The fuel injection unit includes an electrically operated fuel pump for pressuring and discharging the fuel sucked from a fuel tank, and the injector 23 for injecting the high-pressure fuel discharged from the electrically operated fuel pump into the intake port 14 of each cylinder of the engine at optimum timing, and the like. The injector 23 is mounted to the cylinder head 3 of the engine.

In this case, the ignition unit and the fuel injection unit are constructed so as to be driven (energized and controlled) by the ECU 10.

According to this embodiment, the throttle unit is a system for controlling an intake air quantity sucked into the combustion chamber of each cylinder of the engine in response to a throttle opening degree corresponding to the valve opening degree of the throttle valve 4.

The throttle unit includes a throttle body which is integrated with the engine intake pipe 1, the throttle valve 4 for varying an intake air quantity flowing in the engine intake pipe 1 (intake passage 11), and a return spring (or default spring) for biasing the throttle valve 4 in a direction to close the valve (or in a direction to open the valve). Moreover, the throttle body is mounted with an actuator such as an electric motor 27 for driving the throttle valve 4 in a direction to open the valve (or in a direction to close the valve).

In this case, the electric motor 27 is constructed so as to be energized and controlled by the ECU 10.

As described above, according to this embodiment, the intake air vortex generating member is provided with the intake manifold 2 which is hermetically connected with the downstream side of the throttle body of the engine intake pipe 1 in the intake air flow direction (direction of flow of the intake air), and the TCVs each of which produces a vortex in the suction air (intake air) sucked into the combustion chamber of each cylinder of the engine.

Moreover, the TCV has multiple intake air flow control valves 5 which are disposed in the intake passage 13 positioned at the downstream side (in the intake air flow direction) of the throttle valve 4, a housing 7 and an actuator for driving the plurality of intake air flow control valves 5 in a direction to close the valve or in a direction to open the valve via the pin rod 8. The housing 7 houses therein the intake air flow control valves 5, and supports the two end portions of the direction of a rotation axis of a valve shaft (rotary shaft) in such a manner that the two end portions can freely slide in a rotation direction. The valve shaft is formed integrally with the each intake air flow control valve 5.

The intake manifold 2 constructs a common casing of the TCVs disposed in correspondence with the respective cylinders of the engine, and has a plurality of polygonal cylindrical portions 31 in which fitting holes 32 are formed. Each of the polygonal cylindrical portions 31 constructs the outside polygonal cylindrical portion (first cylindrical portion of the casing) of the intake manifold 2 which has a double pipe structure.

The intake manifold 2 is an intake branching pipe for distributing and supplying the intake air flowing into the plurality of polygonal cylindrical portions 31 (intake passages 12, 13) to intake ports 14, which has the number equal to that of the cylinders formed in the cylinder head 3 of the engine. The intake manifold 2 can be integrally molded by a resin material, for example.

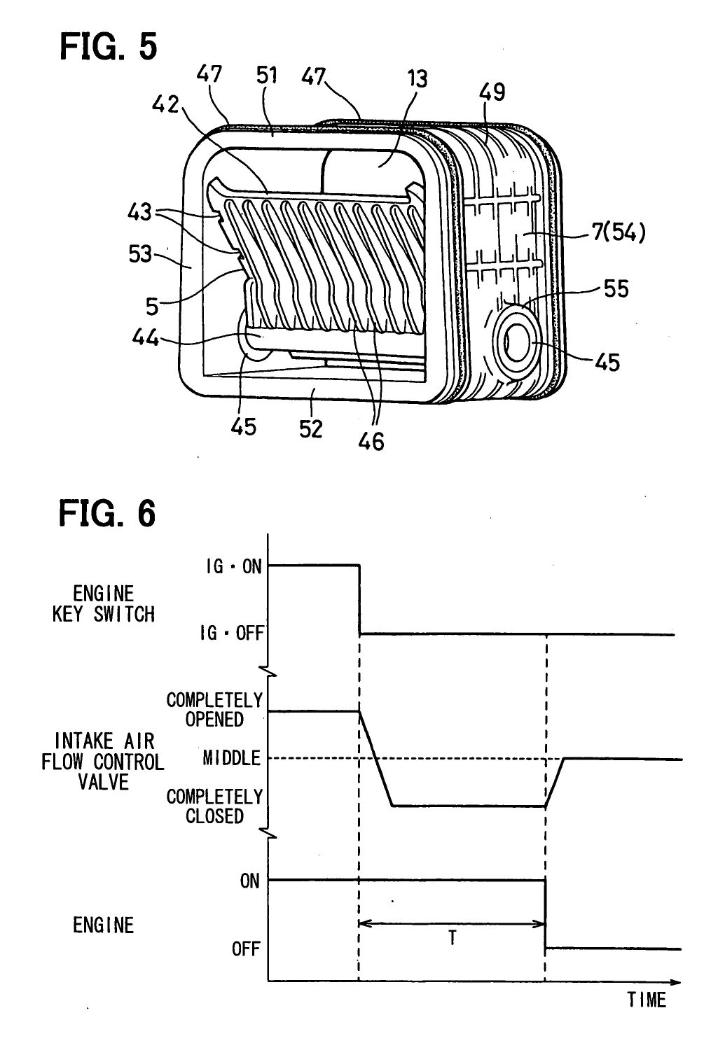

The multiple fitting holes 32 (TCV housing portions, valve unit housing portions) for housing and holding the plurality of valve units (cartridges shown in FIG. 5) are formed respectively in the polygonal cylindrical portions 31 of the intake manifold 2.

Moreover, the plurality of intake passages 12 independently connected to the respective cylinders of the engine are formed in the plurality of polygonal cylindrical portions 31, in other words, the upstream side (in the intake air flow direction) of the respective fitting holes 32 of the intake manifold 2.

The intake passages 12 are connected independently of each other to the intake ports 14 of the respective cylinders of the engine. In this case, the cross-sectional area of the fitting hole 32 is larger than the cross-sectional area of the intake passage 12 formed in the intake manifold 2. Moreover, the fitting hole 32 has a recess portion 33 recessed to a lower side in the drawing than the bottom wall surface of the intake passage 12. The bottom wall surface of the recess portion 33 is connected to the bottom wall surface of the intake passage 12 via a stepped surface 34 formed in the intake manifold 2.

In this case, the intake air vortex generating member includes a plurality of valve units each of which has the intake air flow control valve 5 and a housing 7. The intake air vortex generating member is a compound integral type valve opening/closing device, where the plurality of intake air flow control valves 5 respectively disposed in the plurality of valve units are arranged in parallel at a predetermined interval in the direction of the rotation axis of the pin rod 8 (in the direction of a rotation central axis) in the polygonal cylindrical portions 31 of the intake manifold 2.

Each of the plurality of intake air flow control valves 5 has a polygonal hole (for example, square hole) which penetrates the intake air flow control valve 5 in the direction of the rotation axis of the pin rod 8. Moreover, in this embodiment, a portion (central portion) of the valve top end edge of each of the intake air flow control valves 5, that is, a valve top end surface which is positioned at the opposite side to the valve shaft side of each of the intake air flow control valves 5 is cut out to form a rectangular main opening 42 (i.e., cutout portion such as slit) for generating an intake air vortex (tumble flow) in the intake air to be supplied into the combustion chamber of the each cylinder of the engine. However, the main opening 42 can be also omitted.

Moreover, in this embodiment, the valve left/right side surfaces of each of the intake air flow control valves 5 are partially cut out, so that multiple (e.g., four) subordinate openings 43 (i.e., cutout portion such as slit) each which has a smaller opening area than the main opening 42 are formed. However, the subordinate openings 43 can be also omitted.

Each of the plurality of intake air flow control valves 5 is integrally molded by a resin material, for example. Each of the intake air flow control valves 5 is a plate-shaped valve body, which has a cylindrical valve shaft 44 (valve fitting portion) disposed so as to surround the square hole 41 and is extended to the one side (single side) of the radial direction (which is vertical to the direction of the rotation axis) from the valve shaft 44.

The square hole 41 formed in each of the plurality of intake air flow control valves 5 is a through hole that is extended substantially straight in the direction of the rotation axis vertical to the axial direction (intake air flow direction) of the each intake passage 13 formed in each of the plurality of housings 7. The square hole 41 is formed so as to penetrate each of the valve shafts 44 in the direction of rotation axis. The valve shafts 44 are respectively provided for the plurality of intake air flow control valves 5.

The plurality of intake air flow control valves 5 are rotary valves having a rotation central axis in a direction perpendicular to the axial direction (intake air flow direction) of the each housing 7 and combined with each other so as to be skewered by the one pin rod 8.

The plurality of intake air flow control valves 5 have their rotation angles (valve opening degrees) changed within a valve operating range (valve opening/closing range) from a completely opened position (at which the flow of the intake air flowing in each intake passage 13 becomes maximum) to a completely closed position (at which the flow of the intake air flowing in each intake passage 13 becomes minimum), thereby opening or closing the respective intake passages 13 of the plurality of housings 7.

In the plurality of intake air flow control valves 5, the respective valve shafts 44 are disposed at positions biased to the one side (lower side in the drawing) of the direction of a valve surface vertical to the direction of thickness of each of the plurality of intake air flow control valves 5 in the case where the valve opening degrees of the intake air flow control valves 5 are set in the completely closed state (that is, intake air flow control valve 5 is arranged at a completely closed position to be completely closed). Thus, the plurality of intake air flow control valves 5 construct cantilever type valves each of which has the valve shaft 44 constructing a rotational center at the opposite side to the free end side, respectively.

In this case, each of the valve shafts 44 which are respectively provided for the intake air flow control valves 5 has a cylindrical shape to surround the pin rod 8 in the circumferential direction of the valve shaft 44. Moreover, the two ends of the axial direction of the valve shaft 44 function as two valve sliding portions (valve sliding surfaces) which are rotatably and slidably supported by the inner periphery of each of the valve housings 7 via two bearings 45 (bearing members).

Moreover, the valve shaft 44 is disposed at an offset position which is closer to the bottom wall surface of the housing lower wall portion of the housing 7 than the central axis of the intake passage 13 and which is closer to the upstream side of the intake air flow direction of the intake passage 13 than the central portion of the intake air flow direction of each intake passage 13. In other words, the valve shaft 44 is disposed at a position closer to the open end of the upstream side of the each housing 7 and close to the bottom wall surface (lower surface) of the housing lower wall portion of the each housing 7. For this reason, in the plurality of intake air flow control valves 5, the valve surface of the reverse surface side of the each valve body formed for each of the plurality of intake air flow control valves 5 is opposed to the bottom wall surface of the housing lower wall portion of the each housing 7 with a minimum necessary quantity of clearance between the valve surface and the bottom wall surface in the case where the valve opening degree of each of the intake air flow control valves 5 is set at the fully opened position (that is, each of the intake air flow control valves 5 is completely opened).

Moreover, the TCV has a plurality of reinforcing ribs 46 formed at the valve surface of the reverse surface side of two obverse and reverse surfaces of the intake air flow control valve 5 in such a manner that the reinforcing ribs 46 are gradually decreased in height from the valve shaft 44 to the tip of the intake air flow control valve 5. However, the reinforcing ribs 46 can be also omitted.

In the case where the engine is cooled or the small intake air quantity can satisfy the need, the plurality of intake air flow control valves 5 are completely closed by using the driving force of an actuator such as the electric motor 9. In this embodiment, the intake air flow control valves 5 are disposed so as to be inclined slightly by a specified rotation angle (i.e., completely closed angle and inclined angle) in a direction to open the valve with respect to a vertical line vertical to the axial direction of the intake passage 13.

Moreover, when the engine is in a middle or high rotation range, the plurality of intake air flow control valves 5 are completely opened by the use of driving force of the actuator such as the electric motor 9. In this embodiment, the intake air flow control valves 5 are disposed in such a manner that the two obverse and reverse surfaces of each of the intake air flow control valve 5 are extended in the nearly same direction as the axial direction of the intake passage 13 when the intake air flow control valves 5 are fully opened. When a large quantity of intake air is required, that is, when the engine is in a low rotation speed range, the intake air flow control valves 5 may be controlled so as to be brought from the fully closed position to a half opened position, that is, to a middle state where the intake air flow control valves 5 are slightly opened.

Moreover, electric power is supplied for the electric motor 9 through the plurality of intake air flow control valves 5 after the engine is stopped, and the intake air flow control valves 5 are held at a middle opening degree between the completely-opened opening degree and the completely-closed opening degree. Then, the supply of electric power to the electric motor 9 through the plurality of intake air flow control valves 5 is stopped.

Each of the plurality of housings 7 can be integrally molded by the resin material. The housing 7 houses therein the intake air flow control valve 5 in such a manner that the intake air flow control valve 5 can be freely opened and closed, and rotatably support the two end portions (two valve sliding portions) of the direction of the rotational axis of the valve shaft 44 (which construct the rotational center of the intake air flow control valve 5).

The plurality of housings 7 is elastically supported by the interior of the fitting hole 32 of the intake manifold 2 through two gaskets 47. Moreover, a plurality of reinforcing ribs 49 extending in a peripheral direction and in a direction parallel to the intake air flow direction are formed at the outer peripheral surface of each housing 7. However, the reinforcing ribs 49 can be also omitted.

In this case, the housing 7 can be a polygonal cylindrical body for housing the intake air flow control valve 5 in such a way that the intake air flow control valve 5 can be freely opened and closed and constructs a polygonal cylindrical portion (second cylindrical portion of the casing) inside the intake manifold 2 having a double pipe structure.

Each of these housings 7 has a pair of housing upper and lower wall portions 51, 52 (first opposed wall portions) at both sides of the direction (vertical direction) perpendicular to the axial direction (intake air flow direction) of the intake passage 13.

Moreover, each of the plurality of housings 7 has a pair of housing left and right wall portions 53, 54 (second opposed wall portions) at both sides of the direction (horizontal direction) perpendicular to the axial direction (intake air flow direction) of the intake passage 13.

The plurality of housings 7 are respectively provided with the intake passages 13 therein, which are respectively communicated with the combustion chambers of cylinders of the engine via the plurality of intake ports 14. Moreover, each of the plurality of housings 7 has two valve bearing portions 55 (cylindrical portions) formed therein in such a way that the valve bearing portions 55 are opposed to each other across the intake passage 13. Each of the valve bearing portions 55 is provided with two bearing housing hollows 56 therein, which rotatably house the valve shafts 44 and which are respectively provided for the plurality of intake air flow control valves 5.

Two bearings 45 are fitted by press fitting or the like at the inner peripheries of the bearing housing hollows 56 provided for the two valve bearing portions 55, thereby being held by the inner peripheries. However, the bearings 45 can be also omitted.

In this case, the two valve bearing portions 55 and the two bearing housing hollows 56 are disposed respectively at offset positions which are biased closer to one side (that is, lower side in the drawing and bottom wall surface side) of the housing 7 than the central axis (central axis of the intake passage 13) passing through the center in the up-down direction (in the drawing) of the intake passage 13 and which are biased closer to the upstream side in the intake air flow direction of the intake passage 13 than the central portion of the intake air flow direction of each intake passage 13. In other words, the two valve bearing portions 55 and the two bearing housing hollows 56 are disposed respectively at offset positions which are biased closer to an opening end of the upstream side of the housing 7 and which are close to the bottom wall surface of the housing bottom wall portion 52 of each housing 7.

In this case, a recess portion 57 recessed toward the lower side of the drawing is integrally formed at the upstream side (intake manifold side) of the intake air flow direction of the cylinder head 3 so as to prevent interference between the cylinder head 3 and the intake air flow control valve 5. Moreover, each of the plurality of housings 7 is provided with a recess portion 59, which is recessed toward the lower side of the drawing from the passage wall surface of the intake passage 12 of the intake manifold 2. The bottom wall surface of the recess portion 59 is formed at the same plane as the bottom wall surface of the recess portion 57 of the cylinder head 3 of the engine. The bottom wall surface of the recess portion 59 may be formed at the lower side in the drawing than the bottom wall surface of the recess portion 57.

In this embodiment, the recess portion 57 and 59 construct a dead volume (space) for housing the intake air flow control valve 5 when the intake air flow control valve 5 is set in the completely opening state (that is, the intake air flow control valve 5 is completely opened).

The pin rod 8 is a drive shaft that is inserted by press fitting into the respective square holes 41 formed in the plurality of intake air flow control valves 5 to combine the respective valve shafts 44 of the plurality of intake air flow control valves 5 so as to skewer them, thereby coupling all of the intake air flow control valves 5 so that the intake air flow control valves 5 can be moved in combination with each other.

The pin rod 8 is a shaft having a polygonal cross section and extending substantially straight in the direction of the rotation axis of the pin rod 8, and is pressed into and secured by the inner peripheries of the respective valve shafts 44 which are respectively provided for the intake air flow control valves 5.

In this case, the pin rod 8 of this embodiment is a shaft having a polygonal cross section (polygonal steel shaft) that is constructed of a metal material such as iron in a polygonal shape (for example, square shape) in the cross section perpendicular to the direction of its rotational axis. The pin rod 8 has a plurality of fitting portions (valve holding portions) which are respectively inserted into square holes 41 formed in the intake air flow control valves 5 to hold the valve shafts 44 provided for the intake air flow control valves 5 at a specified valve securing angle.

The square hole 41 formed in the intake air flow control valve 5 is formed in a polygonal shape (square shape) corresponding to the cross-sectional shape (square shape) of the pin rod 8, that is, in the nearly same hole shape as the cross-sectional shape of the valve holding portion of the pin rod 8, whereby the relative rotation between the intake air flow control valve 5 and the pin rod 8 is prevented.

Moreover, even if the pin rod 8 having a polygonal cross-sectional shape is directly supported by the respective bearing housing hollows 56 of the two valve bearing portions 55 of the housing 7, the pin rod 8 cannot be smoothly rotated. For this reason, the pin rod 8 of this embodiment is covered with the respective valve shafts 44 disposed in the plurality of intake air flow control valves 5, and has the outer periphery side of the housing 7 rotatably supported by the two bearings 45 via the two end portions (two valve sliding portions) of the direction of the rotation axis of the valve shaft 44.

In this case, the actuator for driving the valve shafts 44 of the intake air flow control valves 5 in the direction to close the valve or in the direction to open the valve is an electrically operated motor actuator that includes the electric motor 9 supplied with electric power to generate a drive force (motor output shaft torque) and a power transmission mechanism (gear speed reduction mechanism which is not shown) for transmitting the rotational motion of the motor shaft (output shaft) of the electric motor 9 to the pin rod 8.

A DC motor of a brushless DC motor or a DC motor with a brush is employed as the electric motor 9. An AC motor such as a three-phase induction motor may be employed. Moreover, the gear speed reduction mechanism reduces the rotational speed of the motor shaft of the electric motor 9 to a specified speed reduction ratio and constructs the power transmission mechanism for transmitting the motor output torque of the electric motor 9 to the pin rod 8.

Moreover, the gear speed reduction mechanism includes a motor gear secured to the motor shaft of the electric motor 9, an intermediate speed reduction gear engaged with the motor gear, and a final speed reduction gear engaged with the intermediate speed reduction gear.

Moreover, a spring for biasing all of the intake air flow control valves 5 of the TCVs to the direction to open the valve or a spring for biasing all of the intake air flow control valves 5 of the TCVs to the direction to close the valve is combined with the pin rod 8 or the final speed reduction gear.

The valve driving unit, in particular, the electric motor 9 is energized and controlled by the ECU 10. The ECU 10 can be constructed of a microcomputer having a well-known structure to include a CPU for performing control processing and computation processing, a storage device for storing control programs or control logics and various kinds of data (volatile memory such as SRAM and DRAM, or non-volatile memory such as EPROM, EEPROM, or flush memory), an input circuit (input part), an output circuit (output part), a power circuit, and a timer.

Furthermore, the ECU 10 is constructed so as to have an operating position signal inputted to the micro computer built in the ECU 10. The operating position signal is sent from the engine key switch 61 having four operating positions of off (OFF), accessory (ACC), ignition (IG), and starter (STA). The engine key switch 61 is a switching circuit constructed of an engine key and a key cylinder.

Moreover, the ECU 10 is constructed in such a manner that sensor signals from various sensors are A/D converted by an A/D converter and then are inputted to the microcomputer. The various sensors includes a crank angle sensor 62 for detecting the rotational angle of the crankshaft of the engine (engine speed), a throttle opening degree sensor 63 (throttle valve opening detection unit) for detecting the valve opening degree (throttle opening degree) of the throttle valve 4, a cooling water temperature sensor 64 (engine temperature detection unit) for detecting the temperature of an engine cooling water (cooling water temperature, engine temperature of the internal combustion engine) for cooling the engine, an intake air temperature sensor 65 (intake air temperature detection unit) for detecting the temperature of the intake air sucked into the combustion chamber of each cylinder of the engine, an air flow sensor 66 (intake air flow detection unit) for detecting the flow of intake air (intake quantity) sucked into the each combustion chamber of the engine, and a vehicle speed sensor 67 (vehicle traveling speed detection unit) for detecting the traveling speed of a vehicle such as an automobile.

A driving state detection unit for detecting the driving state of the engine and running state detection unit for detecting the running state of the vehicle such as an automobile can be constructed of the crank angle sensor 62, the throttle opening degree sensor 63, the cooling water temperature sensor 64, the intake air temperature sensor 65, the air flow sensor 66, and the vehicle speed sensor 67.

The crank angle sensor 62 is formed of a pickup coil for converting the rotational angle of the crankshaft of the engine to an electric signal and outputs an NE pulse signal for each 30° CA (crank angle), for example. The ECU 10 functions as a rotation speed detection unit for detecting an engine rotation speed (hereinafter referred to as an “engine speed: NE”) by measuring an interval time of the NE pulses outputted by the crank angle sensor 62. Moreover, the cooling water temperature sensor 64 functions as engine temperature detection unit for detecting an engine temperature (engine temperature of the internal combustion engine).

Moreover, the ECU 10 is constructed so as to energize and control the electric motor 9 of the intake air vortex generating member and the electric motor 27 of the throttle unit on the basis of the control programs or the control logics stored in the memory when the engine key 61 is turned on, in other words, the ignition switch is turned on (IG/ON) and so as to drive the ignition unit (ignition coil, spark plug 22, and the like) and the fuel injection unit (electrically operated fuel pump, injector 23, and the like). With this, while the engine is driven, the valve opening degree of the TCVs, the intake air quantity, the fuel injection quantity are controlled so as to become respective control command values (control target values).

In this case, the ECU 10 variably controls electric power to be supplied to the electric motor 9 of the intake air vortex generating member in such a manner that when the engine is started (in particular, when the engine is started after a vehicle such as an automobile is parked (engine is stopped) under cold environment (for example, below a freezing point) in the winter: when the engine is started under the cold environment) and when the engine is idled (when a vehicle such as an automobile is stopped (engine is driven) under cold environment (for example, below a freezing point) in the winter), the valve openings of the TCVs are brought to the state of the completely-closed opening degree where the plurality of intake air flow control valves 5 are completely closed, in other word, the plurality of intake air flow control valves 5 are completely closed.

Moreover, the ECU 10 variably controls electric power to be supplied to the electric motor 9 of the intake air vortex generating member in such a manner that when the engine is normally driven (for example, when a vehicle such as an automobile is running) and when the engine is idled (when a vehicle such as an automobile is stopped (engine is driven) under warm environment except for cold environment in the winter), the valve opening degrees of the TCVs are brought to the state of a completely opened position where the plurality of intake air flow control valves 5 are completely opened, in other word, the plurality of intake air flow control valves 5 are completely opened.

Moreover, the ECU 10 is constructed in such a way that when the engine key switch 61 is turned off, in other words, the ignition switch is turned off (IG/OFF), engine control including the ignition control and the fuel injection control based on the control programs or the control logics stored in the memory is forcibly finished. In this regard, the ECU 10 is constructed in such a way that even if the operating position of the engine key switch 61 is switched from the IG position to the ACC position or the OFF position for the purpose of finishing driving the engine to thereby turn off the engine key switch 61, that is, to thereby turn off the ignition switch (IG/OFF), the engine control (intake control) after turning off the engine key switch 61 shown in a timing chart in FIG. 8 can be continued until a specified condition is satisfied (for example, a specified time passes).

Next, the action of the intake air control device (intake air vortex generating member) of the internal combustion engine of this embodiment will be described in brief with reference to FIG. 1 to FIG. 6. Here, FIG. 6 is a timing chart showing the engine control (valve freeze restricting control) after turning off the engine key switch 61.

When the engine key switch 61 is turned on, that is, the ignition switch is turned on (IG/ON), the ECU 10 energizes and controls the electric motor 27 of the throttle unit and drives the ignition unit (the ignition coil, the spark plug 22, and the like) and the fuel injection unit (the electrically operated fuel pump, the injector 23, and the like). With this, the engine is driven. At this time, when a specific cylinder of the engine is shifted from an exhaust stroke to an intake stroke in which the intake valve 24 is opened and the piston 21 is moved down, negative pressure (pressure lower than the atmospheric pressure) in the combustion chamber of the cylinder is increased as the piston 21 is moved down, whereby an air-fuel mixture is sucked into the combustion chamber through the opened intake port 14.

Moreover, when the engine cooling water temperature detected by the cooling water temperature sensor 64 is not lower than a first specified value, that is, the engine is warmed and the flow of the intake air quantity (intake air quantity) needs to be increased, that is, when the engine is normally driven, the ECU 10 controls the electric power to be supplied to the electric motor 9 (for example, passes electric current through the electric motor 9). At this time, the intake air flow control valves 5 are driven in the direction to open the valve by the use of the drive force of the electric motor 9, thereby being opened. In other words, the intake air flow control valves 5 are controlled in such a way that the valve openings of the TCVs are brought to a state where the TCVs are opened at a valve fully opened position (state of the fully opened opening).

In this case, the intake air flows flowing from the plurality of intake passages 12 of the intake manifold 2 of the engine through the inlets of the respective housings 7 of the TCVs into the respective intake passages 13 (which are respectively provided for the plurality of housings 7) pass straight through the plurality of intake passages 13, and are introduced from the outlets of the plurality of housings 7 into the intake ports 14 formed in the cylinder head 3 of the engine.

The intake air flows passing through the intake ports 14 are supplied to the combustion chambers through the intake valve ports of the intake ports 14. At this time, an intake air vortex (tumble flow) in the longitudinal direction is not generated in the combustion chambers.

On the other hand, when the engine cooling water temperature detected by the cooling water temperature sensor 64 is smaller than a second specified value smaller than the first specified value, that is, the engine is cooled and hence the flow of the intake air (intake air quantity) may be small, in other words, when the engine is started or idled, the ECU 10 controls the electric power to be supplied to the electric motor 9 (for example, passes electric current through the electric motor 9). At this time, the intake air flow control valves 5 are driven in the direction to close the valve by the use of the drive force of the electric motor 9, thereby being closed. In other words, the intake air flow control valves 5 are controlled in such a manner that the valve opening degrees of the TCVs are brought to a state where the TCVs are arranged at a valve completely closed position (that is, TCVs are provided with a completely-closed opening degree).

In this case, the intake air flows flowing from the plurality of intake passages 12 of the intake manifold 2 of the engine through the inlets of the plurality of housings 7 into the plurality of intake passages 13 pass through the clearances (main openings 42) between the valve upper end edge portions of the intake air flow control valves 5 and the passage wall surfaces of the housing upper wall portions 51 of the plurality of housings 7, and are introduced from the outlets of the plurality of housings 7 into the upper layer portions of the intake ports 14, and flow along the top wall surfaces of the upper layer portions of the intake ports 14.

The intake air flows flowing along the top wall surface of the upper layer portions of the intake ports 14 are supplied into the combustion chambers through the intake valve ports of the intake ports 14. At this time, tumble flows are produced in the combustion chambers of the respective cylinders of the engine. Thus, combustion efficiency in the combustion chamber when the engine is started or idled is increased, whereby fuel consumption and emission (for example, HC reduction effect) can be improved.

Here, in the case where a tumble flow is produced when a large intake quantity is required in the low speed rotation range of the engine, even while the engine is driven, the electric power to be supplied to the electric motor 9 may be controlled (for example, electric current may be supplied for the electric motor 9) to control the intake air flow control valves (TCV) in such a manner that the valve opening degrees of the TCVs are brought to a state where the TCVs are opened at a middle opening degree (state of a middle opening degree). In this case, the intake air quantity supplied into the combustion chamber of the each cylinder of the engine is increased to a certain extent to generate a tumble flow. For this reason, combustion efficiency in the combustion chamber in the low speed rotation range of the engine is increased, whereby fuel consumption and emission (for example, HC reduction effect) can be improved.

Moreover, when the engine key switch 61 is turned off for the purpose of stopping the driving of the engine which is being driven (ON), that is, the engine key switch 61 is switched from the IG position to the ACC position or the OFF position, the ECU 10 makes an engine stop control timer start counting time. In other words, when the ignition switch is turned off (IG/OFF), the engine stop control timer starts counting time.

At this time, the ECU 10 drives the ignition unit and the fuel injection unit to continue driving the engine (ON: for example, idling the engine with the throttle opening degree at the completely-closed opening degree at an engine speed lower than a specified value). Furthermore, the ECU 10 controls the electric power to be supplied to the electric motor 9 (for example, electric current is supplied for the electric motor 9). At this time, the intake air flow control valves 5 are driven in the direction to close the valve by the use of the drive force of the electric motor 9, thereby being closed. In other words, the intake air flow control valves 5 are controlled in such a way that the valve opening degrees of the TCVs are brought to a state where the TCVs are closed to be arranged at the valve completely closed position (that is, the TCVs are provided with the completely-closed opening degree).

In this case, the pressure of the each intake passage closer to the combustion chamber than each of the intake air flow control valves 5 of the TCVs (each intake passage 13 formed for each of the plurality of intake ports 14 formed in the cylinder head 3 and for each of the plurality of housings 7) is brought to a state of negative pressure which is larger than or equal to a specified value (intake negative pressure capable of blowing off water adhering to or remaining in the vicinity of the intake air flow control valves 5) as the piston 21 is moved down and the intake valve 24 is opened in the intake stroke of the engine.

Thereafter, when a specified time (a specified period: T) has elapsed since the engine key switch 61 was turned off, the ECU 10 makes the engine stop control timer finish counting time and stops driving the ignition unit and the fuel injection unit to stop the engine completely (OFF). The value counted by the engine stop control timer is reset when the engine is completely stopped. Furthermore, the ECU 10 supplies the electric motor 9 with the electric power to operate all of the intake air flow control valves 5 in the direction to open the valve, whereby the intake air flow control valves 5 are controlled in such a way that the valve openings of the TCVs are brought to a state of an intermediate opening degree between the completely-opened opening degree and the completely-closed opening degree. Then, the ECU 10 stops supplying the electric motor 9 with the electric power (OFF).

As described above, in the intake air control device (intake air vortex generating member) of the internal combustion engine of this embodiment, the cantilever type intake air flow control valve 5 in which the valve shaft 44 is biased to the one side (lower side in the drawing, bottom wall surface side of the housing lower wall portion 52 of the housing 7) of the direction of the valve surface vertical to the thickness direction of the intake air flow control valve 5 is employed as the valve of the TCV.

Moreover, the respective intake air flow control valves 5 are housed in the dead volumes (spaces) formed at the side of the bottom wall surface of the cylinder head 3 of the engine and at the side of the housing lower wall portions of the respective housings 7 of the TCVs without projecting into the intake passages 13 and the intake ports 14 in such a way that the valve surface (flat surface) at the obverse surface side of the two obverse and reverse surfaces of each of the intake air flow control valves 5 is disposed along the intake air flow direction in the case of the completely-opened opening degree where all of the intake air flow control valves 5 are completely opened (when all of the intake air flow control valves 5 are completely opened) and that an intake air resistance is reduced when the intake air flow control valves 5 are completely opened.

Therefore, there is a possibility that when the intake air flow control valves 5 are fully opened, moisture contained in the intake air while the vehicle such as automobile is running or stops or moisture intruding from the outside of the engine intake pipes 1 will be accumulated in the dead spaces for housing the plurality of intake air flow control valves 5.

In this case, as for the moisture intruding from the outside of the engine intake pipes 1, it can be thought that water intrudes when the vehicle such as automobile is washed, when it rains, or when the vehicle passes through a puddle.

Alternatively, when the engine is provided with a positive crankcase ventilation device (PCV device) in which gas (blow-by gas) passing through clearances between the cylinders and pistons 21 of the engine is not purged into the atmosphere but is again introduced into the combustion chambers of the engine through the intake manifold 2 and is again combusted, a large quantity of moisture is contained in the blow-by gas, so that there is a possibility that the moisture contained in the blow-by gas will intrude into the TCVs.

More alternatively, when the engine is mounted with an exhaust recirculation unit (EGR unit) in which part of the exhaust gas flowing out of the combustion chambers of the engine is recirculated through the intake passages 11, 12 and 13 of the engine intake pipes 1, a large quantity of moisture is contained in the exhaust gas, so there is a possibility that the moisture contained in the exhaust gas will intrude into the TCVs. Moreover, there is a possibility that moisture condensed in the engine intake pipes 1 positioned at the upstream side of the TCVs will intrude into the TCVs.

Moreover, the two valve bearing portions 55 are disposed respectively at the housing left and right wall portions 53 and 54 of the each housing 7 of the TCV so as to be opposite to each other across the dead space via the two bearings 45. The two valve bearing portions 55 rotatably support the two end portions (two bearing sliding portions) of the direction of the rotation axis of the valve shaft 44 of each of the intake air flow control valves 5 in such a way that the two end portions can freely rotate.

For this reason, there is a possibility that water collected in the dead space will intrude into also the annular clearance between the valve shaft 44 and the bearing 45 and will be accumulated in the annular clearance. Moreover, there is a possibility that water will be accumulated also in clearances between the valve left and right side surfaces at the two sides of the direction of the rotation axis of each of the intake air flow control valves 5 and the housing side wall surfaces of the housing left and right wall portions 53 and 54 of the each housing 7.

Thus, the engine control system of this embodiment drives the ignition unit and the fuel injection unit to continue driving the engine until the specified time (T) has elapsed since the engine key switch 61 was turned off, that is, the engine key switch 61 was switched from the IG position to the ACC position or the OFF position, and closes all of the intake air flow control valves 5 until the intake air flow control valves 5 are brought to a specified valve closing state, in other words, an intake air pressure that is larger than a pressure difference across the valve and can blow off water adhering to or remaining in the vicinities of the intake air flow control valves 5 is generated.

In other words, the ECU 10 performs the engine stop control of driving the engine only for a specified period immediately after the engine key switch 61 is turned off and controls the electric power to be supplied to the electric motor 9 during the specified period to perform the intake air control of closing the plurality of intake air flow control valves 5 to a specified valve closing state (TCV opening degree control after turning off the engine key switch 61: valve opening degree control of TCV).

As described above, when the engine is driven only for the specified period immediately after the engine key switch 61 is turned off and all of the intake air flow control valves 5 are closed to the specified valve closing state (for example, the state of the completely-closed opening degree), as described above, an intake air pressure at a portion closer to the combustion chamber than all of the intake air flow control valves 5 is brought to the state of the negative pressure which is larger than or equal to the specified value (that is, intake air pressure which is larger than or equal to the pressure difference across the valve and can blow off water) as the piston 21 is moved down and the intake valve 24 is opened in the intake stroke of the engine.

When this state is brought about, while the engine key switch 61 is on (the engine is driven), water adhering to or remaining in the vicinity of the intake air flow control valve 5, in particular, water accumulated in the dead space (recess portion 57 and the like) formed below the intake passage 13 and the intake port 14 is blown off to the combustion chamber of the engine by an intake air negative pressure produced as the piston 21 is moved down and the intake valve 24 is opened, that is, by a strong intake air flow passing through a clearance between the valve upper end edge portion of the intake air flow control valve 5 and the passage wall surface of the housing upper wall portion 51 of the housing 7 and a strong intake air flow passing through clearances between the valve left and right side surfaces of the intake air flow control valve 5 and the housing side walls of the housing left and right wall portions 53, 54 of the housing 7.

Moreover, water that intrudes from the dead space into the annular clearance between the valve shaft 44 of the intake air flow control valve 5 and the bearing 45 and remains in the clearance and water that remains in the clearance between the valve left and right side surfaces of the intake air flow control valve 5 and the housing side wall surfaces of the housing 7 are sucked out into the combustion chamber of the engine by the strong intake air flow.

Here, when all of the intake air flow control valves 5 are closed to the state of the totally closed opening degree, water adhering to or remaining in the vicinities of the intake air flow control valves 5 is blown off (or sucked out) to the combustion chambers of the engine by the intake air negative pressure produced as the piston 21 is moved down and the intake valve 24 is opened, that is, by a strong main intake air flow passing through one main opening 42 and a strong subordinate intake air flow passing through four subordinate openings 43. The main opening 42 and the subordinate openings 43 are formed for each of the plurality of intake air flow control valves 5.

When or immediately after the engine key switch 61 is turned off, the water adhering to or remaining in the vicinities of the intake air flow control valves 5 can be removed by the use of the intake air negative pressure of the engine, that is, the strong intake air flows (main intake air flow and subordinate intake air flow) passing through the clearances between the intake air flow control valves 5 and the passage wall surfaces of the housings 7.

Thus, when or immediately after the specified time (T) passes after the engine key switch 61 is turned off, that is, when or immediately after driving the engine is stopped, water is removed from the vicinities of the intake air flow control valves 5. Therefore, the intake air flow control valves 5 can be restricted from being frozen or being brought into a malfunction by the icing of water adhering to or remaining in the vicinities of the intake air flow control valves 5 after the engine is stopped or when the engine is started next time under cold environment.

Thus, even when the vehicle mounted with the engine is parked or stopped under cold environment (below the freezing point) in the winter or the like, if all of the intake air flow control valves 5 are closed to have the completely-closed opening degree when the engine is started next time under the cold environment, an intake air vortex (tumble flow) in the longitudinal direction can be generated in the intake air sucked into the combustion chamber of the engine when or immediately after the engine is started under the cold environment. With this, when the engine is started under the cold environment, combustion efficiency in the combustion chamber of the engine can be increased whereby fuel consumption and emission can be improved. Moreover, the controllability or the controllability of the intake air of the each intake air flow control valve 5 of the TCV when the engine is started under the cold environment can be improved.

The actuator can be controlled in such a way as to close the TCV until the pressure at the portion closer to the combustion chamber than the intake air flow control valve 5 of the TCV is brought to the state of the negative pressure which is larger than or equal to the specified value (specified valve closing state) until a predetermined period has elapsed since the engine key switch 61 was turned off. In this case, for example, assuming that the totally closed opening θ=0°, the intake air flow control valves 5 are closed to a specified valve closing state (θ=0 to 30°).

Moreover, the specified period (T) may be a fixed value (for example, 0.5 to 2.0 seconds) previously measured by an experiment or the like or may be a variable value varying according to the temperature of the intake air detected by the intake air temperature sensor 65 or an outside air temperature. Moreover, the specified period (T) may be varied according to a temperature difference between the temperature of the intake air detected by the intake air temperature sensor 65 or the outside air temperature and the engine cooling water temperature (engine temperature) detected by the cooling water temperature sensor 64. For example, it is preferable that as water easily adhere to or remains in the vicinities of the intake air flow control valves 5, the specified time (T) is elongated.

### Second Embodiment

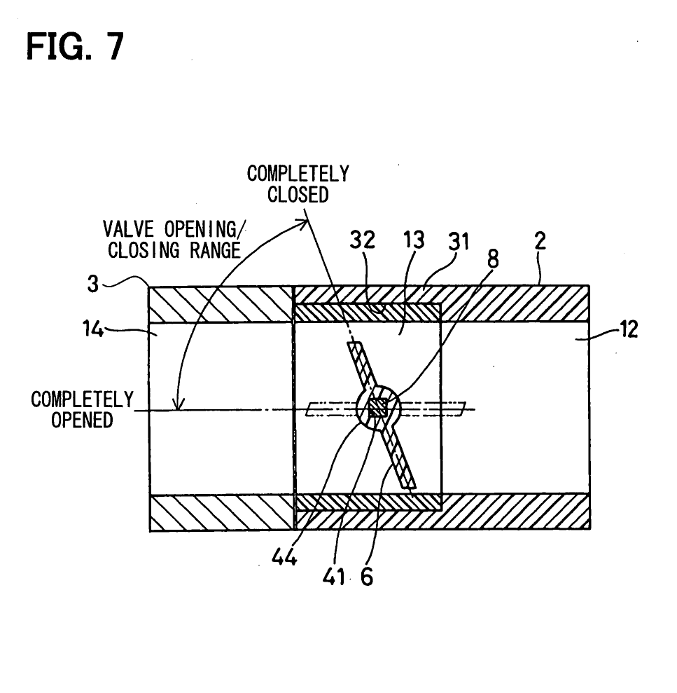

A second embodiment of the present invention will be described with reference to FIG. 7.

According to the second embodiment, in the TCV, an inboard intake air flow control valve 6 (butterfly valve) having the valve shaft 44 disposed nearly in the central portion of the direction of a valve surface substantially vertical to the thickness direction of the intake air flow control valve 5 is employed as an intake air flow control valve.

A rectangular main opening (cutout, slit) for producing an intake air vortex (tumble flow) in the intake air supplied into the combustion chamber of the each cylinder of the engine may be formed by cutting out the valve upper end surface of the one end (upper end in the drawing) of the direction of the valve surface vertical to the thickness direction of the intake air flow control valve 6.

Moreover, subordinate openings (cutouts, slits) each of which has a smaller opening area than the main opening may be formed by cutting out part of the valve left and right side surfaces of the intake air flow control valve 6.

In this embodiment, the passage opening cross-sectional area of the intake passage 12 of the intake manifold 2 is nearly equal to the passage opening cross-sectional area of the intake passage 13 of the housing 7. Therefore, the dead space formed in the embodiment 1 is not formed.

Also in the engine control system of this embodiment, by driving the ignition unit and the fuel injection unit to continue driving the engine for the period until the specified time (T) has elapsed since the engine key switch 61 was turned off and by closing all of the intake air flow control valves 6 until all of the intake air flow control valves are brought to a specified valve closing state, the same effect as in the embodiment 1 can be provided.

In this embodiment, the intake air control device of the internal combustion engine is applied to the intake air control device of the internal combustion engine mounted with the intake air vortex generating member. However, the intake air-control device of the internal combustion engine may be applied to an intake air quantity control device (throttle opening control device) of the internal combustion engine for controlling an intake air quantity sucked into the combustion chamber of the each cylinder of the internal combustion engine and a variable intake air control device of the internal combustion engine having an intake air varying valve for varying a passage length or a passage cross-sectional area of an intake passage.

In this embodiment, the intake air vortex generating member is constructed so as to produce an intake air vortex (tumble flow) in the longitudinal direction for promoting the combustion of the air-fuel mixture in the combustion chamber of each cylinder of the engine. However, the intake air vortex generating member can be also constructed so as to produce an intake air vortex (swirl flow) in the lateral direction for promoting the combustion of the air-fuel mixture in the combustion chamber of each cylinder of the engine. Moreover, the intake air vortex generating member can be also constructed so as to produce a squish vortex for promoting the combustion in the engine.

In this embodiment, the valve driving unit (actuator) for opening or closing the valve shafts 44 of the intake air flow control valves 5 is constructed of the electrically operated actuator having the electric motor and the power transmission mechanism. However, the actuator for opening or closing the shafts of the intake air flow control valves can be also constructed of a negative pressure operated actuator having an electromagnetic or electrically operated negative pressure control valve, or an electromagnetic actuator having an electromagnet such as a coil and a moving core (or armature).

In this regard, there is no need to dispose a valve biasing unit such as a spring for biasing the valve shafts 44 of the intake air flow control valves 5 in the direction to open the valve or in the direction to close the valve. The spring can be constructed of a return spring for biasing the valve shafts 44 of the intake air flow control valves 5 in the direction to open the valve or in the direction to close the valve, or a default spring for biasing the valve shafts 44 of the intake air flow control valves 5 in the direction to close the valve or in the direction to close the valve, or the like.

Moreover, in place of the TCV of this embodiment, an intake air flow quantity control valve having a throttle valve (4), which is disposed in the intake passage formed in the throttle body and controls a suction air quantity (intake air quantity) sucked into the combustion chamber of the engine, or an intake air flow quantity control valve, which has an idling rotational speed control valve disposed in the intake passage formed in the housing and controls a suction air quantity (intake air quantity) bypassing the throttle valve (4) may be used as the intake air control valve, which has a valve disposed in the intake passage formed in the casing and controls a suction air (intake air) sucked into the combustion chamber of the engine.

Furthermore, an intake passage opening/closing valve, an intake passage switching valve, or an intake air pressure control valve can be used as the intake air control valve having the intake air control valve in place of the intake air flow control valve or the intake air flow quantity control valve. Still further, the intake air control valve of the present invention can be applied to an intake air flow control valve such as a tumble flow control valve (first embodiment and second embodiment) and a swirl flow control valve, and an intake air varying valve for varying a passage length or a passage cross-sectional area of an intake passage. Still further, a diesel engine may be used as the engine. Still further, not only a multiple cylinder engine but also a single cylinder engine may be used as the engine.

Moreover, there may be employed a constantly-closed type intake air flow control valve through which electric current is supplied for the electric motor to completely open the intake air flow control valves when the engine is normally driven and by which the supply of the electric current for the electric motor is stopped to completely close the intake air flow control valves when the engine is started or idled.

Furthermore, there may be employed a constantly-opened type intake air flow control valve by which the supply of electric current for the electric motor is stopped to fully open the intake air flow control valves when the engine is normally driven and through which the electric current is supplied for the electric motor to completely close the intake air flow control valves when the engine is started or idled.

Moreover, this embodiment employs the compound integral type valve opening/closing device in which a plurality of valve units (in each of which the one intake air flow control valve 5 is combined in the one housing 7 so as to be freely opened and closed) are disposed at specified intervals in the direction of the rotation axis of the pin rod 8 in the intake manifold 2 as the casing. However, a multiple integral type valve opening/closing device in which a plurality of valves are directly disposed at specified intervals in the direction of the rotation axis of a shaft in the casing (other engine intake pipe, engine head cover, or cylinder head). In this case, the housing 7 can be eliminated.

Furthermore, the intake air control valve is not limited to the compound integral type intake air flow control valve but may be either one cantilever valve or one inboard valve if the valve is disposed in the intake passage.

In this embodiment, all of the intake air flow control valves 5 (6) are closed (completely closed) only for the specified period after the engine key switch 61 is turned off. However, in the case of an actuator capable of individually opening and closing the plurality of intake air flow control valves 5 (6), at least one intake air flow control valve 5 (6) of the plurality of intake air flow control valves 5 (6) may be closed (completely closed) only for the period after the engine key switch 61 is turned off.

In this embodiment, each of the intake air flow control valves 5 has the main opening 42 and the subordinate opening 43 formed therein, but the intake air flow control valve 5 may have either the main opening 42 or the subordinate opening 43 formed therein. Moreover, the main opening 42 and the subordinate opening 43 at the intake air flow control valve 5 can be also omitted.

Moreover, the intake air flow control valve 5 may be combined in the engine intake pipe 1 other than the intake manifold 2 or may be combined in the intake port 14 of the cylinder head 3 of the engine. Furthermore, the passage opening cross-sectional area of the intake passage 12 of the intake manifold 2 may be nearly equal to the passage opening cross-sectional area of the intake passage 13 of the housing of the TCV. That is, the dead space can be also omitted.

Furthermore, in this embodiment, the facade shape of the intake air flow control valve 5 is formed in the square or rectangular shape. However, the facade shape of the intake air flow control valve 5 may be formed in a circular, ellipsoidal, elongated circular, or polygonal shape, or the like. In this case, the cross-sectional shape of the intake passage in the cylindrical portion of the casing is changed in correspondence with the front shape of the intake air flow control valve 5.

What is claimed is:

1. A control device for an internal-combustion engine, the control device comprising:
a casing having an intake passage through which intake air is supplied to a combustion chamber of the internal-combustion engine;
an intake air control valve which is arranged at the intake passage;
an actuator for actuating a shaft of the intake air control valve; and
an engine control unit for controlling the actuator based on an operation state of the internal-combustion engine, wherein
the engine control unit continues an operation of the internal-combustion engine until a predetermined period has elapsed since an engine key switch became OFF, and controls the actuator such that an opening degree of the intake air control valve is in a predetermined valve closed state where the intake air control valve is closed.

2. The control device according to claim 1, wherein
the actuator is controlled to close the intake air control valve until a pressure at a portion closer to the combustion chamber than the intake air control valve is brought to a state of a negative pressure which is larger than or equal to a specified value, so that the opening degree of the intake air control valve is in the predetermined valve closed state.

3. The control device according to claim 1, wherein
the casing has a housing which houses therein the intake air control valve and slidably supports a shaft of the intake air control valve.

4. The control device according to claim 3, wherein:
the shaft of the intake air control valve is a rotation shaft which constructs a rotation center of the intake air control valve;
the intake air control valve is a cantilever type valve where the rotation shaft is biased to one side of a valve surface direction of the intake air control valve; and
the rotation shaft is rotatably supported at the housing of the casing.

5. The control device according to claim 3, wherein:
the shaft of the intake air control valve is a rotation shaft which constructs a rotation center of the intake air control valve;
the intake air control valve is a cantilever type valve where the rotation shaft is arranged at a substantial middle portion of the valve surface direction of the intake air control valve; and
the rotation shaft is rotatably supported at the housing of the casing.

6. The control device according to claim 1, wherein
the engine control unit controls the actuator such that the opening degree of the intake air control valve is in a completely-closed opening degree state where the intake air control valve is completely closed, when the internal-combustion engine is started under a cold environment.

7. The control device according to claim 6, further comprising
an intake air vortex generating member having an opening which is formed at a part of the intake air control valve by cutting out to generate a vortex in the intake air.

8. The control device according to claim 1, further comprising
a driving state detection unit for detecting a driving state of the internal-combustion engine, wherein
the engine control unit controls the actuator based on the driving state detected by the driving state detection unit.

9. The control device according to claim 1, further comprising
an engine temperature detection unit for detecting a temperature of the internal-combustion engine, wherein
the engine control unit controls the actuator based on the temperature detected by the engine temperature detection unit.

10. The control device according to claim 1, further comprising
an intake air temperature detection unit for detecting a temperature of the intake air sucked into the combustion chamber of the internal-combustion engine, wherein
the engine control unit controls the actuator based on the temperature of the intake air detected by the intake air temperature detection unit.

11. The control device according to claim 1, further comprising
an intake air flow detection unit for detecting an intake quantity of the intake air sucked into the combustion chamber of the internal-combustion engine, wherein
the engine control unit controls the actuator based on the intake quantity of the intake air detected by the intake air flow detection unit.

12. The control device according to claim 1, further comprising:
a throttle valve for controlling an intake quantity of the intake air sucked into the combustion chamber of the internal-combustion engine; and
a throttle valve opening degree detection unit for detecting an opening degree of the throttle valve, wherein
the engine control unit controls the actuator based on the opening degree of the throttle valve detected by the throttle valve opening degree detection unit.

13. The control device according to claim 1, further comprising
a rotation speed detection unit for detecting a rotation speed of the internal-combustion engine, wherein
the engine control unit controls the actuator based on the rotation speed of the internal-combustion engine detected by the rotation speed detection unit.

14. The control device according to claim 1, further comprising
a vehicle traveling speed detection unit for detecting a traveling speed of a vehicle where the internal-combustion engine is mounted, wherein
the engine control unit controls the actuator based on the traveling speed of the vehicle detected by the vehicle traveling speed detection unit.

15. The control device according to claim 1, wherein
the intake air control valve is an intake air flow control valve for generating a vortex in the intake air sucked into the combustion chamber of the internal-combustion engine.

16. The control device according to claim 13, wherein
the rotation speed detection unit is constructed of the engine control unit.
